(19) United States
(12) Patent Application Publication
(10) Pub. No.: US 2024/0087002 A1
(43) Pub. Date: Mar. 14, 2024

(54) PROCESSING DEVICE, PROCESSING METHOD, AND PROCESSING PROGRAM

(71) Applicant: NTT QONOQ, INC., Chiyoda-ku (JP)

(72) Inventors: Toshimitsu NAKAMURA, Chiyoda-ku (JP); Misa YAMAZAKI, Chiyoda-ku (JP); Sachiyo KAWAHARA, Chiyoda-ku (JP)

(73) Assignee: NTT QONOQ, INC., Chiyoda-ku (JP)

(21) Appl. No.: 18/262,325

(22) PCT Filed: Jan. 21, 2022
(86) PCT No.: PCT/JP2022/002254

§ 371 Date: Jul. 20, 2023

(30) Foreign Application Priority Data
Jan. 22, 2021 (JP) 2021-009180

(51) Int. Cl. G06Q 30/0601; G06Q 30/0241; G06Q 30/0251

(52) U.S. Cl. CPC G06Q 30/0643; G06Q 30/0269; G06Q 30/0277; G06Q 30/0631

(57) ABSTRACT

A server device (10) includes: a construction unit (132) configured to construct a virtual shopping mall including virtual stores from which a user is able to browse and purchase products in a virtual space and to provide the constructed virtual shopping mall to a user terminal used by the user; and an optimization unit (134) configured to change at least one of virtual stores which are arranged in the virtual shopping mall, advertisements which are arranged in the virtual shopping mall, products which are arranged in the virtual stores, and advertisements which are arranged in the virtual stores for each user according to user information of users entering the virtual shopping mall.

### TECHNICAL FIELD

The present invention relates to a processing device, a processing method, and a processing program.

### BACKGROUND ART

In the related art, purchase of products by using a web site (an electronic commerce (EC) site) selling products over the Internet is generally used. Recently, techniques of providing the same extent of purchase experiences as purchase of products in actual stores to users by reproducing stores in a virtual space and cooperating with an EC site have been proposed.

### CITATION LIST

### Patent Literature

Patent Literature 1: Japanese Unexamined Patent Publication No. 2004-220074

### SUMMARY OF INVENTION

### Technical Problem

Products which are provided by using a virtual store are set for each store, for example, based on trends or best-selling products at that time. However, it often takes time for a user to find a product satisfying the user's taste out of these products. In actual stores, a store assistant can bring out products with a color or shape satisfying the user's taste, but such processing over the Internet is often troublesome.

The present invention was made in consideration of the aforementioned circumstances, and an objective thereof is to provide a processing device, a processing method, and a processing program that can provide an optimal shopping environment in a virtual space for each user.

### Solution to Problem

In order to solve the aforementioned problem and to achieve the aforementioned objective, a processing device according to the present invention includes: a construction unit configured to construct a virtual shopping mall including virtual stores from which a user is able to browse and purchase products in a virtual space and to provide the constructed virtual shopping mall to a user terminal used by the user; and a changing unit configured to change at least one of virtual stores which are arranged in the virtual shopping mall, advertisements which are arranged in the virtual shopping mall, products which are arranged in the virtual stores, and advertisements which are arranged in the virtual stores for each user according to user information of users entering the virtual shopping mall.

A processing device according to the present invention includes: a construction unit configured to construct a virtual store from which a user is able to browse and purchase products in a virtual space and to provide the constructed virtual store to a user terminal used by the user; and a changing unit configured to change products which are arranged in the virtual store and advertisements which are arranged in the virtual store for each user according to user information of users entering the virtual store.

### Advantageous Effects of Invention

According to the present invention, it is possible to provide an optimal shopping environment in a virtual space for each user.

### BRIEF DESCRIPTION OF DRAWINGS

FIG. 1 is a block diagram illustrating an example of a configuration of a communication system according to an embodiment.

FIG. 2 is a block diagram illustrating an example of a configuration of a server device illustrated in FIG. 1.

FIG. 3 is a diagram illustrating an example of a data structure of user information.

FIG. 4 is a diagram illustrating an example of a data structure of store and product information.

FIG. 5 is a diagram illustrating an example of a virtual reality (VR) shopping mall which is displayed on a user terminal used by a user.

FIG. 6 is a diagram illustrating an example of a VR shopping mall which is displayed on a user terminal used by a user.

FIG. 7 is a diagram illustrating an example of an inside view of a VR shopping store which is displayed on a user terminal used by a user.

FIG. 8 is a sequence diagram illustrating a processing sequence of a communication process which is performed by the communication system according to the embodiment.

FIG. 9 is a diagram illustrating a computer that executes a program.

### DESCRIPTION OF EMBODIMENTS

Hereinafter, a processing device, a processing method, and a processing program according to an embodiment of the present invention will be described in detail with reference to the accompanying drawings. The processing device, the processing method, and the processing program according to the present invention are not limited to the embodiment.

In the following embodiment, a routine of processes in a processing device, a processing method, and a processing program according to the embodiment will be sequentially described, and advantageous effects of the embodiment will be described thereafter.

### EMBODIMENT

The embodiment will be first described below. In this embodiment, a communication system for providing a shopping environment in a virtual space to a user will be described.

In a communication system according to the embodiment, a server device on a VR store provider side that provides a shopping environment to a user reproduces a virtual street in a virtual space and constructs a virtual shopping mall (a VR shopping mall) including a plurality of virtual stores (VR stores) in the street. At this time, the server device changes VR stores or advertisements arranged in the VR shopping mall and changes products or advertisements arranged in the VR stores to satisfy a taste of a user who enters the VR shopping mall. Accordingly, the user can easily recognize stores and products satisfying the user's taste and be provided with an optimal shopping environment in the virtual space.

[Configuration of Communication System]

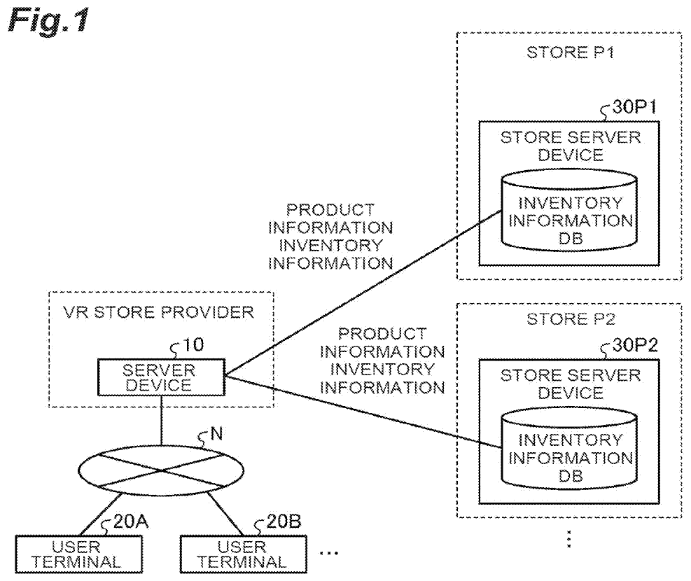

A configuration of the communication system according to the embodiment will be described below. FIG. 1 is a block diagram illustrating an example of the configuration of the communication system according to the embodiment.

As illustrated in FIG. 1, the communication system according to the embodiment includes user terminals 20A and 20B which are used by users and a server device 10 (a processing device) of a VR store provider. The server device 10 is linked to store server devices 30P1 and 30P2 of stores P1 and P2 selling products. The configuration illustrated in FIG. 1 is only an example and a specific configuration and the numbers of devices are not particularly limited.

The server device 10 (the processing device) of the VR store provider receives information on products which can be displayed in VR stores and an advertisement from the store server devices 30P1 and 30P2 of the stores P1 and P2 selling products, and provides a user with VR stores in which the products are displayed and a VR shopping mall including the VR stores and street advertisements. In a VR store, a user can refer to feature information such as a type, a color, and a size of a product by selecting the product, and perform a product purchase process by performing a predetermined process. The server device changes stores or advertisements arranged in the VR shopping mall and products or advertisements arranged in the VR stores for each user based on user information such that a user's taste is satisfied when VR shopping is provided to the user.

Each of the store server devices 30P1 and 30P2 includes an inventory information DB of products stored therein. The store server devices 30P1 and 30P2 transmit information on products which can be displayed in the corresponding VR stores or advertisements thereof out of products stored therein to the server device 10 via a network or the like. The store server devices 30P1 and 30P2 transmit identification information, a name, a size, a color, a price, and inventory information of each product as product information. The store server devices 30P1 and 30P2 are generically referred to as a store server device 30.

Each of the user terminals 20A and 20B is an information processing device such as a notebook personal computer (PC) or a desktop PC or a smart device such as a tablet or a smartphone. The user terminals 20A and 20B are linked to the server device 10 via a network N and are provided with a VR shopping mall. The user terminals 20A and 20B perform browsing of stores or advertisements in a shopping mall, browsing of products and advertisements in a VR store, and purchase of a product in the provided VR shopping mall.

In this embodiment, when a VR shopping mall is provided to users, it is possible to provide each user with an optimal shopping environment in a virtual space, by changing stores or advertisements arranged in the VR shopping mall and changing products or advertisements arranged in a VR store, for each user to satisfy the user's tastes. The server device 10 illustrated in FIG. 1 will be described below.

[Server Device]

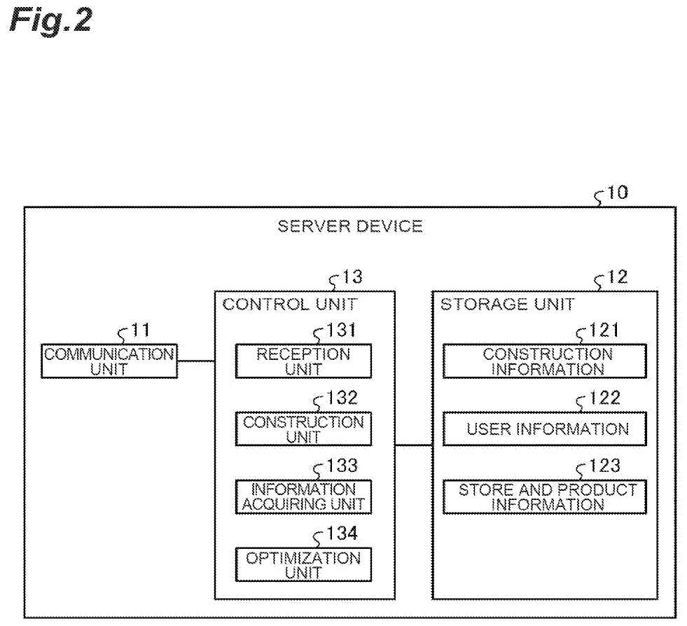

FIG. 2 is a block diagram illustrating an example of a configuration of the server device 10 illustrated in FIG. 1. As illustrated in FIG. 2, the server device 10 includes a communication unit 11 controlling communication of various types of information, a storage unit 12 storing data and programs required for various processes which are performed by a control unit 13, and the control unit 13 performing various processes. The processes of the constituent units of the server device 10 will be described below.

The communication unit 11 is a communication interface that transmits and receives various types of information to and from another device linked thereto via a network or the like. The communication unit 11 is realized by a network interface card (NIC) or the like and performs communication between another device and the control unit 13 (which will be described later) via an electrical communication line such as a local area network (LAN) or the Internet. For example, the communication unit 11 receives information on displayable products from the store server device 30 via the network. The communication unit 11 receives an entrance request for a VR shopping mall, an entrance request for a VR store, and a browse request or a purchase request for products, from the user terminal 20 via the network N. The communication unit 11 transmits information on a product purchase procedure and inventory update after purchase of a product to the store server device 30.

The storage unit 12 is a storage device such as a hard disk drive (HDD) or a solid state drive (SSD). The storage unit 12 may be a data-rewritable semiconductor memory such as a random access memory (RANI), a flash memory, or a nonvolatile static random access memory (NVSRAM). The storage unit 12 stores an operating system (OS) or various programs which are executed by the server device 10. The storage unit 12 stores various types of information which are used to execute the programs. The storage unit 12 stores construction information 121, user information 122, and store and product information 123.

The construction information 121 is information required to construct a VR shopping mall and a VR store in a virtual space. The construction information 121 includes image processing conditions and image processing programs for constructing a VR shopping mall and a VR store in a virtual space. For example, when a VR shopping mall and a VR store are constructed as a planet in which products can be seen through one view in a photo VR or a space in a sphere of 360°, the construction information 121 includes an image obtained by imaging a streetscape, outside views of stores, and inside views and products of stores from a fixed point or by 360° or images of the VR shopping mall and the VR store formed by processing the images. For example, when the VR shopping mall and the VR stores are constructed by computer graphics (CG), the construction information 121 is an image in which a streetscape, outside views of stores, and inside views and products of stores are reproduced.

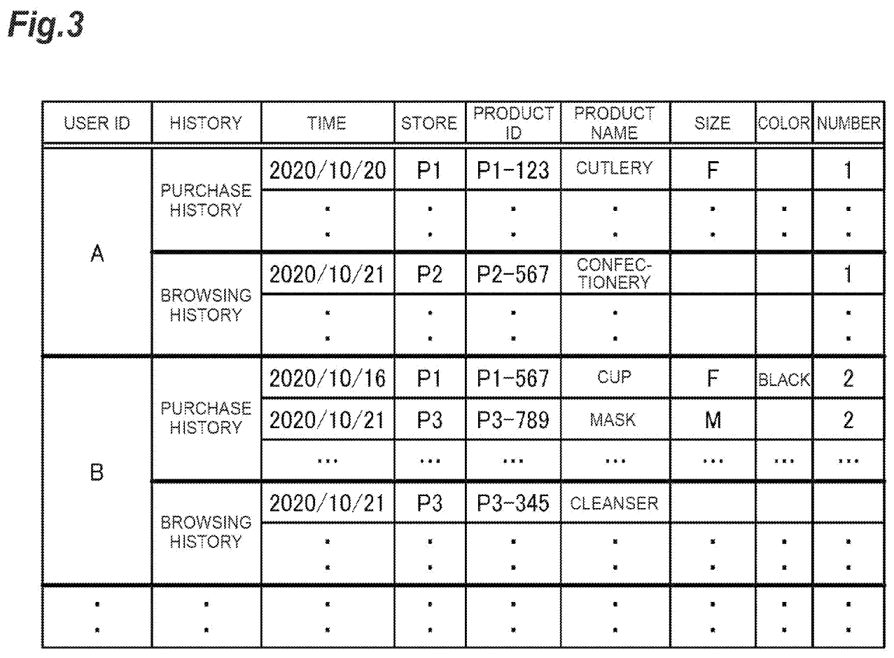

The user information 122 is information on users who are registered as visitors of the VR shopping mall. FIG. 3 is a diagram illustrating an example of a data structure of the user information 122. As illustrated in FIG. 3, the user information 122 includes, for example, IDs of users and purchase histories and browse histories correlated with the user IDs. For example, a purchase history includes a purchase time, a name of a store in which a product has been purchased, a product ID, a product name, a product size, a product color, and a number of products as items. For example, a browsing history includes a browse time, a name of a store in which a product has been browsed, a product ID, a product name, a product size, a product color, and a number of products as items. For example, a record indicating that a user A has purchased and browsed cutlery or confectionery in the stores P1 and P2 is stored as a history, and a record indicating that a user B has purchased and browsed a cup, a mask, and a cleanser in the stores P1 and P3 is stored as a history.

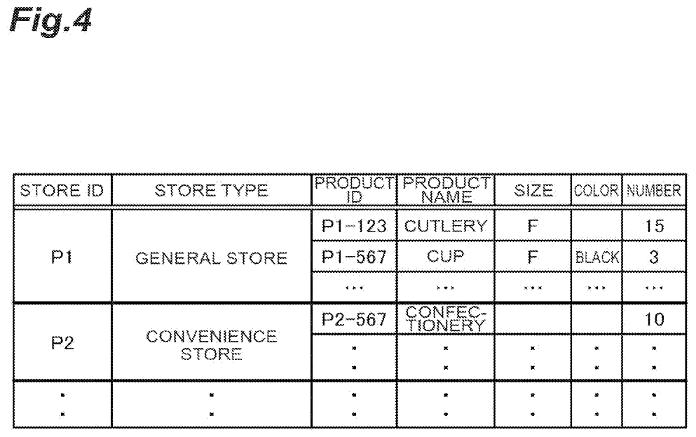

The store and product information 123 is information on stores which are arranged in the VR shopping and products which are displayed in the VR stores. FIG. 4 is a diagram illustrating an example of a data structure of the store and product information 123. As illustrated in FIG. 4, the store and product information 123 includes a store ID and a store type, and further includes a product ID, a product name, a product size, a product color, and a number of products which can be displayed in each VR store or advertisement out of products stored in the store as items. For example, the store P1 is a general store, and displayable products or cutlery and cups are described along with features such as sizes and colors of the products and the number of inventory products.

The control unit 13 controls the server device 10 as a whole. The control unit 13 is, for example, an electronic circuit such as a central processing unit (CPU) or a micro processing unit (MPU) or an integrated circuit such as an application-specific integrated circuit (ASIC) or a field-programmable gate array (FPGA). The control unit 13 includes an internal memory storing programs for defining various process routines or control data and performs various processes by using the internal memory. The control unit 13 serves as various processing units by causing various programs to operate. The control unit 13 includes a reception unit 131, a construction unit 132, an information acquiring unit 133, and an optimization unit (changing unit) 134.

The reception unit 131 receives entrance of a user into a VR shopping mall, entrance into a VR store in the VR shopping mall, browse of a product, and purchase of a product.

The construction unit 132 constructs a VR shopping mall and VR stores in a virtual space by using a photo VR, a planet, or CG. When entrance of a user into a VR shopping mall is received, the construction unit 132 acquires the construction information 121 and constructs a VR shopping mall in a virtual space. The construction unit 132 provides the VR shopping mall to the user terminal 20 used by a user. The construction unit 132 may change landscapes of a streetscape in the VR shopping mall or products displayed in the VR stores for each season.

In the VR shopping mall, arrangement of stores, outside views of the stores, roads, and corresponding advertisements are constructed based on an actual streetscape. In the VR shopping mall, a user can allow an avatar of the user to walk as if the user walks in the actual streetscape. In the VR shopping mall, the user can enter the selected VR store, for example, by clicking or tapping a store name displayed in an outside view of the store or an entrance of the store.

When entrance of a user into a VR store is received, the construction unit 132 constructs the VR store in the virtual space. Then, the construction unit 132 provides the constructed VR store to the user terminal 20 which is used by the user.

In a VR store, an inside view is constructed based on an actual store, and displayable products out of products stored in the actual store are displayed by using a display method in the actual store (arrangement in a line in a showcase or the like). As for the displayed products, product information (type, color, shape, size, price, and inventory) is provided to be browsed. The displayed products can also be purchased. In the VR store, an advertisement of products displayed in the store and the like can also be displayed in an arbitrary region in the store.

When entrance of a user into the VR shopping mall is received, the construction unit 132 may construct VR stores which are arranged in the VR shopping mall along with the VR shopping mall.

The information acquiring unit 133 acquires user information of a user who has requested entrance into the VR shopping out of the information included in the user information 122. The information acquiring unit 133 acquires information on stores arranged in the VR shopping mall and products displayed in the VR stores from the store and product information 123. The information acquiring unit 133 acquires trends of this season, vogue information, best-selling product information, and the like from an external device or the like via a network or the like.

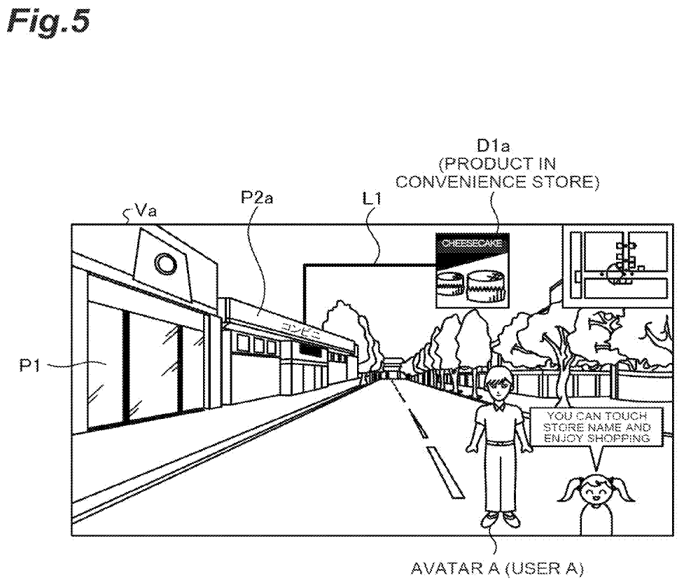

The optimization unit 134 changes at least one of VR stores arranged in the VR shopping mall, advertisements arranged in the VR shopping mall, products arranged in the VR stores, and advertisements arranged in the VR stores for each user to correspond to user information of the user entering the VR shopping mall. The optimization unit 134 optimizes, for each user, the VR stores arranged in the VR shopping mall and arrangement positions thereof, products displayed on the advertisements arranged in the VR shopping mall, a line-up of the products arranged in the VR stores and arrangement positions of the products, and products displayed on at least one of advertisements arranged in the VR stores. The optimization in the VR shopping mall and the VR stores for each user will be described below with reference to FIGS. 5 to 7.

[Example of User Optimization]

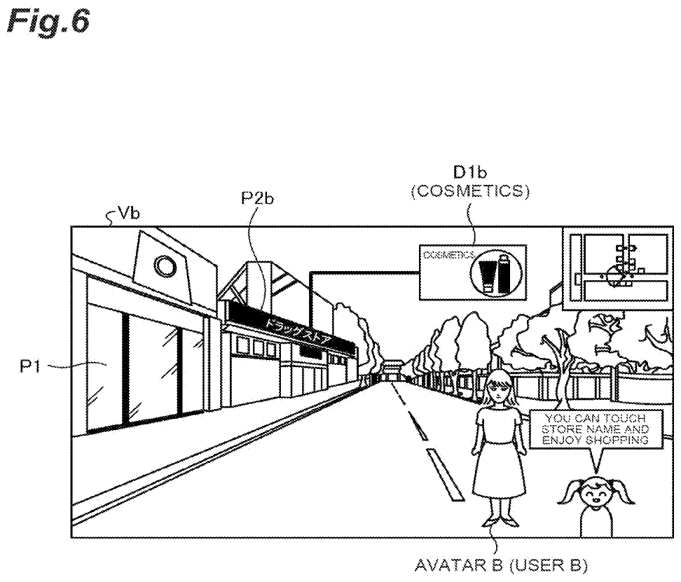

Optimization in the VR shopping mall for each user will be first described below with reference to FIGS. 5 to 6. FIG. 5 is a diagram illustrating an example of a VR shopping mall which is displayed on a user terminal 20A used by a user A. FIG. 6 is a diagram illustrating an example of a VR shopping mall which is displayed on a user terminal 20B used by a user B.

As displayed on screens Va and Vb illustrated in FIGS. 5 and 6, the optimization unit 134 provides a screen in which a streetscape in which a plurality of stores are arranged is reproduced in a virtual space as a VR shopping mall to the users. As displayed on the screens Va and Vb, a map and an image indicating a currently facing direction of the user are displayed on the upper-right side, and an avatar explaining a method of entering stores in the VR shopping mall or the like is displayed on the lower-right side. An avatar of the user (for example, an avatar A of the user A or an avatar B of the user B) is also displayed.

When the user A enters the VR shopping mall as illustrated in FIG. 5, a store P1 (a general stored) and a store P2a (a convenience store) (see FIG. 3) in which the user A browsed or purchased products in the past are sequentially arranged from the closest in the descending order of the number of browses and the number of purchases. When the user A enters the VR shopping mall, a product D1a (a convenience store product (for example, a cheese cake)) of the store P2a in which the user A browsed or purchased products in the past is displayed on a street advertisement L1. This product D1a is a product which is the same as a product browsed or purchased in the store P2a in the past by the user A or a product which has similar features thereto. Alternatively, the product D1a is a product which is a best-selling product at the time of entrance of the user B into the VR shopping mall out of products having similar features to the products browsed or purchased in the store P2a in the past by the user A.

On the other hand, when the user B enters the VR shopping mall, a store P2 (a general stored) and a store P2b (a pharmacy) (see FIG. 3) in which the user B browsed or purchased products in the past are sequentially arranged from the closest in the descending order of the number of browses and the number of purchases as displayed on the screen Vb illustrated in FIG. 6. When the user B enters the VR shopping mall, a product D1b (a piece of cosmetics) of the store P2b in which the user B browsed or purchased products in the past is displayed on the street advertisement L1. This product D1b is a product which is the same as a product browsed or purchased in the store P2b in the past by the user B or a product which has similar features thereto. Alternatively, the product D1b is a product which is a trend at the time of entrance of the user A into the VR shopping mall or a new product of the same brand as the product browsed or purchased in the past by the user B out of products having similar features to the products browsed or purchased in the store P2b in the past by the user B.

In this way, the optimization unit 134 changes at least one of VR stores arranged in the VR shopping mall and arrangement positions thereof and products displayed in an advertisement arranged in the VR shopping mall for each user based on vogue information including a trend, best-selling products, and new products in the season in which a user enters the VR shopping mall and a product purchase history and a product browsing history of the user. That is, in this embodiment, the arrangement positions of the VR stores in the VR shopping mall and advertisement details are optimized for each user. The optimization unit 134 correlates the VR stores arranged in the VR shopping mall and the products displayed in the advertisement arranged in the VR shopping mall which are simultaneously displayed on the screen (see a line L1 in FIG. 5) to promote the products to the user.

Accordingly, when a user enters the VR shopping mall, the VR stores in which the user browsed or purchased a product in the past are sequentially arranged and thus the user can rapidly enter the VR store satisfying the user's taste. The user can rapidly recognize a product satisfying the user's taste or a product such as a best-selling product through the advertisement in the VR shopping mall and smoothly perform browse or purchase of a product.

For example, the optimization unit 134 compares the browsing history and the purchase history of the user A with a product-listed table indicating products displayed in the VR shopping mall and selects the same product as the product browsed or purchased in the past by the user A, products in the same series, products having similar features (such as type, color, shape, or size) thereto, or best-selling products or products corresponding to the trend out of the products having similar features.

The optimization unit 134 may select a product displayed in the street advertisement L1, for example, by using a model. The model learns features (such as type, color, shape, or size) of products browsed or purchased in the past by the user A for each VR store with reference to the browsing history and the purchase history of the user A, for example, by using products browsed or purchased in one season by the user A, products displayed in the same season in the VR stores in which the products were browsed or purchased, and trends, vogues, and best-selling products in the season as training data. The optimization unit 134 constructs a model for each user and selects a product which is displayed on the advertisement arranged in the VR shopping mall by using the model corresponding to each user.

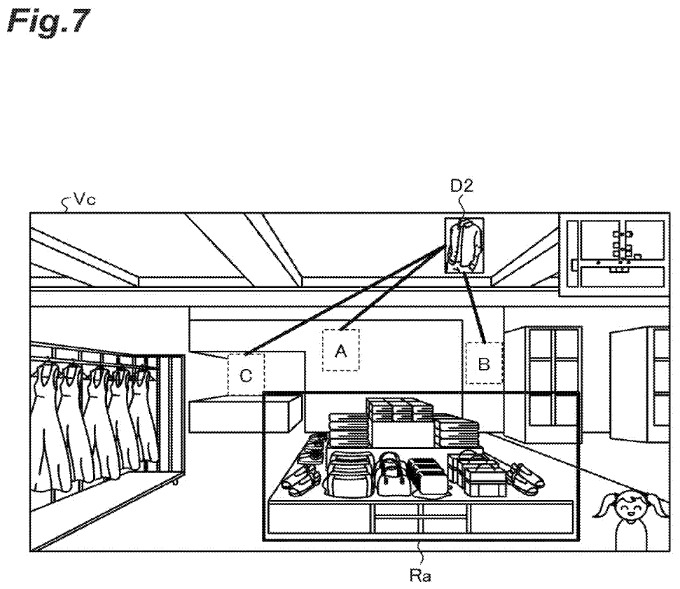

Optimization in a VR store for each user will be described below with reference to FIG. 7. FIG. 7 is a diagram illustrating an example of an inside view of a VR store which is displayed on a user terminal 20 used by a user C.

As displayed on a screen Vc illustrated in FIG. 7, when a user C enters a VR store, the optimization unit 134 arranges products having similar features to products browsed or purchased in the past by the user C in a showcase of a region Ra to which the sight-line of the user C is directed based on sight-line information of the user C. Alternatively, the optimization unit 134 arranges products which are best-selling products at the time of entrance of the user C into the VR shopping mall out of the products having similar features to products browsed or purchased in the past by the user C in a showcase in the region Ra to which the sight-line of the user C is directed. At this time, the optimization unit 134 sequentially arranges products similar to products of which the number of browses or the number of purchases is large on the front side of the showcase.

Then, the optimization unit 134 displays a product D2 having similar features to the product browsed or purchased in the past by the user C in the advertisement of one of regions A to C to which the sight-line of the user is directed based on the sight-line information of the user. Alternatively, the optimization unit 134 displays best-selling products at the time of entrance of the user C into the VR shopping mall out of the products having similar features to products browsed or purchased in the past by the user C in the advertisement in one of the regions A to C. The sight-line information is, for example, information required to estimate a region to which the sight-line of the user C is directed such as an angle of the sight-line estimated based on an operation of an image, a magnification rate of the image, and a position of a pointer.

In this way, the optimization unit 134 changes at least one of a line-up of products arranged in the VR store and a product displayed in the advertisement arranged in the VR store for each user based on the vogue information and the product purchase history and the product browsing history of the user C. The optimization unit 134 changes at least one of arrangement positions of products arranged in the VR store and arrangement position of advertisements arranged in the VR store for each user based on the sight-line information of the user.

That is, in this embodiment, details of the line-up of products in the VR store and the advertisements in the VR store are optimized for each user, and the arrangement positions of products or advertisements are also optimized. Accordingly, in this embodiment, a user can rapidly recognize a product satisfying the user's taste or the vogue and smoothly perform browse or purchase of a product by arranging products satisfying the user's taste or the trend or advertisements of the products in a place to which the sight-line of the user is directed.

Products arranged in the showcase of the region Ra and products displayed in the advertisements in the regions A to C are products having similar features to the products browsed or purchased in the past by the user C. Alternatively, the products arranged in the showcase of the region Ra are products in the trend at the time of entrance of the user into the VR shopping mall, best-selling products, or new products of the same brand as the products browsed or purchased in the past by the user out of the products having similar features to the products browsed or purchased in the past by the user.

The optimization unit 134 compares the browsing history and the purchase history of the user C with a product-listed table indicating, for example, products displayed in the VR store as the products displayed in the showcase of the region Ra and the products displayed in the advertisements of the regions A to C and selects the same products as the products browsed or purchased in the past by the user C, products in the same series, products having similar features (such as type, color, shape, or size) thereto, or best-selling products or products corresponding to the trend out of the products having similar features. The optimization unit 134 may select products displayed in the showcase of the region Ra and products displayed in the advertisements of the regions A to C by using the model constructed for each user.

At this time, the optimization unit 134 may select, arrange, and display a plurality of types of products such that the user C can coordinate the user's whole body. For example, when the user C browses beige shoes in the VR store, the optimization unit 134 may arrange beige shoes which are similar to the beige shoes and which are best-selling products in this season in the front row of the showcase and arrange a beige bag and a bag of brown which is a trend color in this season which match the beige shoes well in the same row as the beige shoes. The optimization unit 134 arranges a sweater of a color matching the shoes in an upper part in the same showcase. The optimization unit 134 may enable the user C to recognize a plurality of types of products satisfying the vogue and the user's taste at a time by arranging various products matching the vogue along with the products satisfying the taste of the user C.

The optimization unit 134 changes at least one of products displayed in the advertisements arranged in the VR shopping mall, the line-up of products arranged in the VR store, and products displayed in the advertisements arranged in the VR store based on inventory information of products. The optimization unit 134 displays only products in stock in the advertisements arranged in the VR shopping mall and the advertisements arranged in the VR store and adds only the products to the line-up of products arranged in the VR store. Accordingly, since products out of stock are not displayed or arranged, a user does not have to perform useless processing such as browse or purchase of the products out of stock. [Processing sequence of communication process]

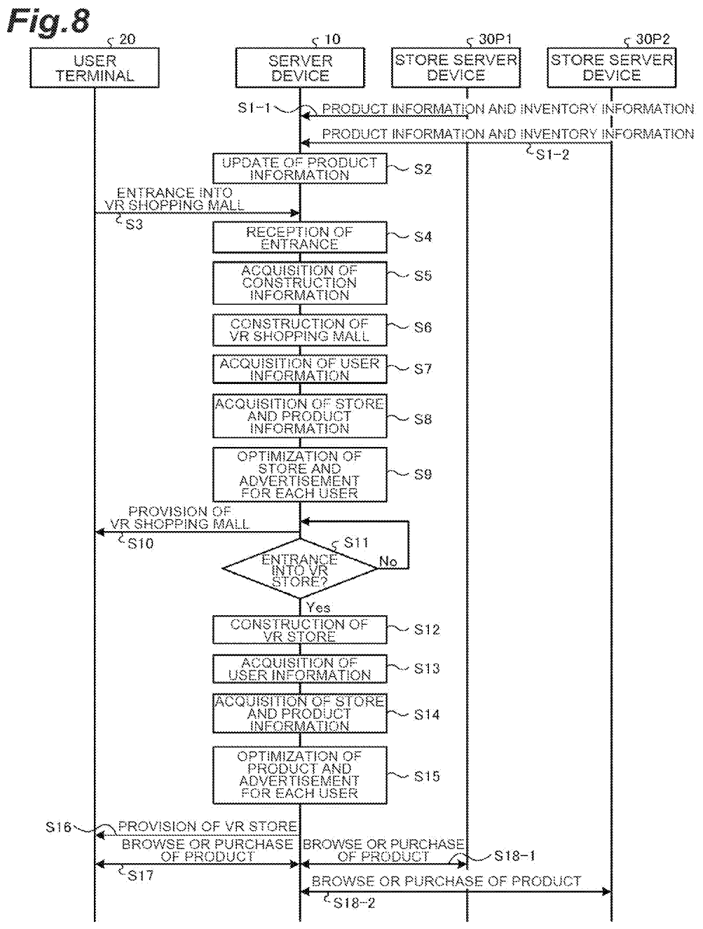

FIG. 8 is a sequence diagram illustrating a processing sequence of a communication process which is performed by the communication system according to the embodiment.

As illustrated in FIG. 8, when product information and inventory information are received from the store server device 30P1 and 30P2 (Steps S1-1 and S1-2), the server device 10 updates the store and product information 123 (Step S2).

When the server device 10 receives an entrance request for a VR shopping mall from a user terminal 20 (Step S4), the construction unit 132 acquires the construction information 121 (Step S5) and constructs a VR shopping mall in a virtual space (Step S6). In the server device 10, the information acquiring unit 133 acquires user information of the user having requested to enter a shopping mall, information on stores arranged in the VR shopping mall and products displayed in VR stores, and vogue information in this season (Steps S7 to S8).

In the server device 10, the optimization unit 134 changes and optimizes VR stores arranged in the VR shopping mall and advertisements arranged in the VR shopping mall for each user based on the acquired user information of the user entering the VR shopping mall, the acquired store and product information, and the acquired vogue information (Step S9). Then, the server device 10 provides the VR shopping mall optimized for the user having requested to enter the shopping mall, to the user terminal 20 (Step S10).

Subsequently, in the server device 10, the reception unit 131 determines whether entrance of the user into the VR store has been received (Step S11). When the server device 10 has received entrance of the user into the VR store (Step S11: YES), the construction unit 132 constructs a VR store which the user is to enter in the virtual space (Step S12). In the server device 10, the information acquiring unit 133 acquires the user information of the user having requested to enter the VR store, information on products displayed in the VR store which the user is to enter, and vogue information in this season (Steps S13 to S14).

In the server device 10, the optimization unit 134 changes and optimizes products arranged in the VR store and advertisements arranged in the VR store for each user based on the acquired user information of the user, the acquired product information of the VR store, and the vogue information (Step S15). Then, the server device provides the VR store optimized for the user having requested to enter the store, to the user terminal 20 (Step S16).

Then, a process of browsing or purchasing a product is performed between the user terminal 20 and the store server device 30P1 and 30P2 via the server device 10 (Steps S17, S18-1, and S18-2). The inventory information is updated with the purchasing process. The optimization unit 134 changes display of products based on the newest inventory information. For example, the optimization unit 134 does not display products out of stock and changes the products to other similar products or best-selling products.

[Advantageous Effects of Embodiment]

In this way, according to this embodiment, it is possible to provide a shopping environment in a virtual space optimal for each user by changing products or advertisements arranged in a VR store for each user such that the user's taste is satisfied when the user is provided with VR shopping.

In this embodiment, a virtual street is reproduced in a virtual space, a VR shopping mall including a plurality of VR stores is constructed in the street, and VR stores arranged in the VR shopping mall and advertisements arranged in the VR shopping mall are changed for each user. Accordingly, according to the embodiment, it is possible to provide a shopping environment equal to actual shopping while walking on the street and optimal for each user to the users in the virtual space.

[System Configuration and Others]

The constituents of the devices illustrated in the drawings are functional and conceptual and do not have to be physically configured as illustrated in the drawings. That is, specific details of distribution and combination of the devices are not limited to those illustrated in the drawings, and all of some thereof can be functionally or physically distributed and combined in arbitrary units depending on various types of load or usage. All or some of the processing functions which are performed in the devices may be realized by a CPU or a GPU and programs which are analyzed and executed by the CPU or the GPU may be realized by hardware based on wired logics.

All or some of processes which are described to be automatically performed out of the processes described in this embodiment may be performed manually, or all or some of the processes described to be manually performed may be performed automatically by using a known method. In addition, the processing sequence, the control sequence, the specific names, and the information including various types of data or parameters which are described in this specification or the drawings can be arbitrarily modified unless otherwise mentioned.

[Program]

A program in which the routine of processes which are performed by the server device 10 described in the embodiment are written in a computer-executable language may be prepared. For example, a program in which the processes performed by the server device 10 according to the embodiment are written in a computer-executable language may be prepared. In this case, by causing a computer to execute the program, it is possible to achieve the same advantages as in the embodiment. The same processes as in the embodiment may be realized by recording the program on a computer-readable recording medium and causing a computer to read and execute the program recorded on the recording medium.

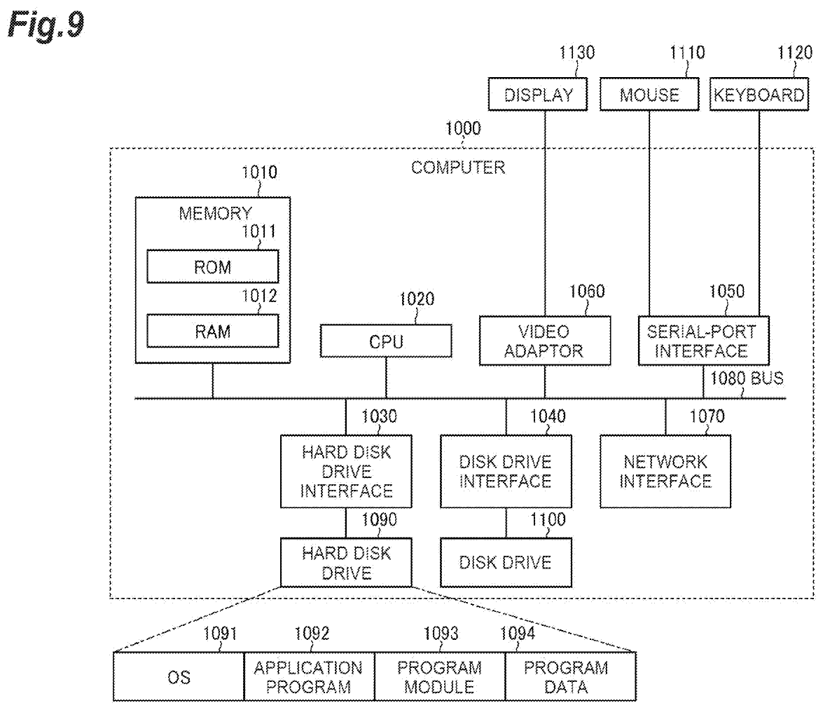

FIG. 9 is a diagram illustrating a computer that executes a program. As illustrated in FIG. 9, a computer 1000 includes, for example, a memory 1010, a CPU 1020, a hard disk drive interface 1030, a disk driver interface 1040, a serial-port interface 1050, a video adaptor 1060, and a network interface 1070, and these constituents are connected via a bus 1080.

The memory 1010 includes a read only memory (ROM) 1011 and a RANI 1012 as illustrated in FIG. 9. The ROM 1011 stores, for example, a booting program such as a basic input output system (BIOS). The hard disk drive interface 1030 is connected to a hard disk drive 1090 as illustrated in FIG. 9. The disk driver interface 1040 is connected to a disk driver 1100. For example, a detachable storage medium such as a magnetic disk or an optical disc is inserted into the disk driver 1100. The serial-port interface 1050 is connected to, for example, a mouse 1110 and a keyboard 1120. The video adaptor 1060 is connected to, for example, a display 1130.

As illustrated in FIG. 9, the hard disk drive 1090 stores, for example, an OS 1091, an application program 1092, a program module 1093, and program data 1094. That is, the aforementioned program is stored as a program module in which commands executed by the computer 1000 are written, for example, in the hard disk drive 1090.

Various types of data described above in the embodiment are stored as program data, for example, in the memory 1010 or the hard disk drive 1090. The CPU 1020 reads the program module 1093 or the program data 1094 stored in the memory 1010 or the hard disk drive 1090 into the RANI 1012 according to necessity and performs various processing sequences.

The program module 1093 or the program data 1094 associated with the program is not limited to being stored in the hard disk drive 1090, but may be stored, for example, in a detachable storage medium and be read by the CPU 1020 via the disk driver or the like. Alternatively, the program module 1093 or the program data 1094 associated with the program may be stored in another computer linked via a network (such as a local area network (LAN) or a wide area network (WAN)) and be read by the CPU 1020 via the network interface 1070.

The aforementioned embodiment and modifications thereof are included in the technology disclosed in the present disclosure and are also included in a scope equivalent to the inventions described in the appended claims

### REFERENCE SIGNS LIST

10 Server device
11 Communication unit
12 Storage unit
13 Control unit
20, 20A, 20B User terminal
30P1, 30P2 Store server device
121 Construction information
122 User information
123 Store and product information
131 Reception unit
132 Construction unit
133 Information acquiring unit
134 Optimization unit

1. A processing device comprising processing circuitry configured to:
construct a virtual shopping mall including virtual stores from which a user is able to browse and purchase products in a virtual space and to provide the constructed virtual shopping mall to a user terminal used by the user; and
change at least one of:
(1) virtual stores which are arranged in the virtual shopping mall,
(2) advertisements which are arranged in the virtual shopping mall,
(3) products which are arranged in the virtual stores, and
(4) advertisements which are arranged in the virtual stores,
for each user according to user information of users entering the virtual shopping mall.

2. The processing device according to claim 1, wherein the user information includes a purchase history of products and a browsing history of products of each user, and
wherein the processing circuitry changes at least one of:
(a) virtual stores arranged in the virtual shopping mall and arrangement positions thereof,
(b) products which are displayed in advertisements arranged in the virtual shopping mall,
(c) a lineup of products arranged in the virtual stores and arrangement positions of the products, and
(d) products which are displayed in the advertisements arranged in the virtual stores,
for each user based on vogue information and the purchase history of products and the browsing history of products of the users.

3. The processing device according to claim 1, wherein the processing circuitry changes at least one of:
(i) arrangement positions of products arranged in the virtual stores and
(ii) arrangement positions of advertisements arranged in the virtual stores,
for each user based on sight-line information of the users.

4. The processing device according to claim 3, wherein the processing circuitry arranges products having features similar to products which were purchased or browsed in the past by a user in a front row of a showcase to which the user's sight-line is directed based on the sight-line information of the user.

5. The processing device according to claim 1, wherein the processing circuitry displays products having features similar to products which were purchased or browsed in the past by a user in an advertisement of an area to which the user's sight-line is directed based on the sight-line information of the user.

6. The processing device according to claim 1, wherein the processing circuitry changes at least one of:
(x) products which are displayed in the advertisements arranged in the virtual shopping mall,
(y) a lineup of products arranged in the virtual stores, and
(z) products which are displayed in the advertisements arranged in the virtual stores,
based on inventory information of the products.

7. A processing device comprising processing circuitry configured to:
construct a virtual store from which a user is able to browse and purchase products in a virtual space and to provide the constructed virtual store to a user terminal used by the user; and
change products which are arranged in the virtual store or advertisements which are arranged in the virtual store for each user according to user information of users entering the virtual store.

8. A processing method that is performed by a processing device, the processing method comprising:
constructing a virtual shopping mall including virtual stores from which a user is able to browse and purchase products in a virtual space and providing the constructed virtual shopping mall to a user terminal used by the user; and
changing at least one of:
(1) virtual stores which are arranged in the virtual shopping mall,
(2) advertisements which are arranged in the virtual shopping mall,
(3) products which are arranged in the virtual stores, and
(4) advertisements which are arranged in the virtual stores,
for each user according to user information of users entering the virtual shopping mall.

9. A non-transitory computer readable storage medium storing a program causing a computer to execute steps of:
constructing a virtual shopping mall including virtual stores from which a user is able to browse and purchase products in a virtual space and providing the constructed virtual shopping mall to a user terminal used by the user; and
changing at least one of:
(1) virtual stores which are arranged in the virtual shopping mall,
(2) advertisements which are arranged in the virtual shopping mall,
(3) products which are arranged in the virtual stores, and
(4) advertisements which are arranged in the virtual stores,
for each user according to user information of users entering the virtual shopping mall.

10. The processing device according to claim 2, wherein the processing circuitry changes at least one of:
(i) arrangement positions of products arranged in the virtual stores and
(ii) arrangement positions of advertisements arranged in the virtual stores,
for each user based on sight-line information of the users.
